(19) United States
(12) Patent Application Publication
(10) Pub. No.: US 2026/0302405 A1
(43) Pub. Date: Oct. 1, 2026

(54) DYNAMIC THERMAL MANAGEMENT SYSTEM FOR TRACTION BATTERY PACKS IN ELECTRIC VEHICLES

(71) Applicant: International Business Machines Corporation, Armonk, NY (US)

(72) Inventors: Michael Boone, Lutz, FL (US); Sarbajit Kumar Rakshit, Kolkata (IN); Carolina Garcia Delgado, Zapopan (MX); Evelyn R. Anderson, Pinehurst, TX (US)

(21) Appl. No.: 19/076,533

(22) Filed: Mar. 11, 2025

(51) Int. Cl. H01M 10/633; H01M 10/44; H01M 10/48; H01M 10/613; H01M 10/615; H01M 10/625; H01M 10/6566

(52) U.S. Cl. CPC H01M 10/633; H01M 10/441; H01M 10/486; H01M 10/613; H01M 10/615; H01M 10/625; H01M 10/6566; H01M 2220/20

(57) ABSTRACT

An approach for dynamically adjusting cooling elements for a traction battery of an EV(electric vehicle), in order to manage thermal conditions and minimize lithium dendrite growth may be provided. The approach continuously monitors the temperature generated by the individual battery cells inside the traction battery (sequentially connected or in parallel). Furthermore, the embodiment optimizes airflow path for effectively managing, enhance thermal efficiency and utilizing the generated heat from the individual battery cells.

### TECHNICAL FIELD

The present invention relates generally to transportation, and specifically, for optimizing battery associated with EVs (Electrical Vehicle).

### BACKGROUND

Electric power for EVs are provided by a traction battery pack. The traction battery packs can be made with individual smaller set of battery cells. Each of the battery cells undergoes various changes (e.g., chemical, thermal, etc.) as it discharges the electricity to power the EVs. Additionally, there can be a mechanical crack, that can be caused by thermal stress and likelihood that the crack can increase if the cathode or anode (terminal areas of the battery cell) are in thermal stress. Thus, these various changes can cause the battery cells to fail.

One reason for battery cell failure can include, but it is not limited to, internal short circuits. Internal short circuits are caused by lithium dendrite formation. A Li-ion (lithium-ion) battery operating under abnormal conditions (i.e., stress), such as overcharging or lower temperature charging, can lead to a harmful phenomenon called lithium dendrite growth or lithium plating. Lithium dendrites are metallic microstructures that form on the negative electrode during the charging process. Lithium dendrites are formed when extra lithium ions accumulate on the anode (i.e., negative terminal) surface and cannot be absorbed into the anode in time.

### BRIEF SUMMARY

According to an embodiment of the present invention, a computer-implemented method for dynamically adjusting and directing airflow elements inside a traction battery of an EV(electric vehicle), the computer-implemented method comprising: identifying each of a plurality of battery cells within the battery pack to assess battery factors; simulating a first scenario from one or more scenarios, by CFD (computational fluid dynamics), a first flow of air through the battery pack; monitoring a first heat value generated from a first airflow circuit within the battery pack, wherein the first airflow circuit is between a first battery cell of the plurality of battery cells and a second battery cell of the plurality of battery cells; creating a first recommendation based on a first result from a first simulation associated with the first scenario and the first heat value; controlling, based on a first result of the first recommendation, a first array of valves associated with the first airflow circuit, wherein the first array of valves controls the first flow of air within the one or more airflow circuits; and switching from the first battery cell to a second battery cell based on the first recommendation.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a computing environment 100, according to embodiments of the present invention;

FIG. 2 is a high-level system architecture of a battery management environment, designated as EV battery management system 200, that is capable of efficiently managing battery cells in a traction battery, according to embodiments of the present invention;

FIG. 3 is, a block diagram of an exemplary system, designated as airflow circuits 300, depicting thermal management of individual cells in the traction battery, in accordance with aspects of the invention;

FIG. 4 illustrates a flowchart, as one embodiment, depicting the execution of EV battery management program 150 as method 400, which can optimize airflow path and switching battery cells for effectively managing and utilizing the generated heat from the battery cells; and

FIG. 5 illustrates another flowchart, as another embodiment and designated as hi-level overview EV 500, depicting a high-level process flow of EV battery management system 200.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the current art of electric vehicle (EV) traction battery, when the lithium-ion battery (i.e., traction battery) operates under abnormal conditions, such as overcharging or lower temperature charging (i.e., typically, below the freezing point of liquids), the batteries may develop a harmful phenomenon, lithium dendrite growth or lithium plating. Lithium plating is a metallic microstructure that forms on the negative electrode during the charging process.

Additionally, excessive heat generation in the traction battery of an EV reduces battery lifespan, efficiency, and performance of the traction battery. For example, the excessive heat generation can pose safety risks, such as, fires or explosions. In another example, colder temperatures (i.e., typically, below the freezing point of liquids) hinder battery efficiency and capacity. Thus, in colder climates or countries, there is an opportunity to recover heat from the battery cells and use it for preheating other battery cells within the traction battery.

The following description discloses several embodiments for dynamically adjusting cooling elements for a traction battery of an EV, to manage thermal conditions and minimize lithium dendrite growth. The embodiment continuously monitors the temperature generated by the individual battery cells inside the traction battery (sequentially connected or in parallel). Furthermore, the embodiment optimizes airflow path for effectively managing, enhance thermal efficiency and utilizing the generated heat from the individual battery cells.

The term, “traction battery,” used throughout this disclosure refers to the combined individual battery cells. These conglomeration of individual battery cells may all be housed inside one battery casing.

The terms, “batteries” or “battery cells” or “individual battery cells,” may be used interchangeably but refers to the individual battery cells that make up a “traction battery.”

The terms, “simulation,” “simulating,” or “scenarios” maybe used interchangeably but refers to simulation analysis which is different than scenario analysis. Scenario analysis uses a model to examine potential futures and predict the various results and outcomes. However, simulation analysis creates a detailed model that mimics real-world processes to analyze various scenarios and provides a more dynamic, robust and complex representation of reality compared to conceptual approach of scenario analysis.

The terms, “airflow path” and “airflow circuits” maybe used interchangeably but denotes the same terminology, air path for inlet and outlet between each battery cells. The airflow circuit can be defined as one or more passage (e.g., tunnels, tubes, etc.) that allow air to travel between sets of individual battery cells inside a battery pack (traction battery casing). Thus, there can be multiple airflow circuits within a battery pack since there can be numerous battery cells with interconnected “air passage” throughout the battery casing.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

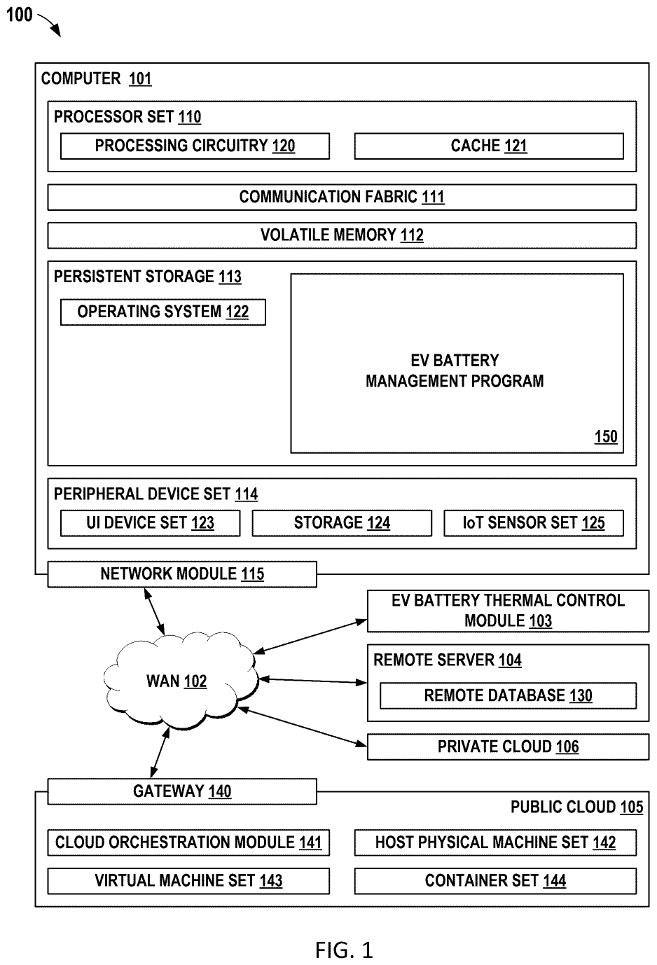

FIG. 1 includes computing environment 100, which contains an example of an environment for the execution of at least some of the computer code involved in performing the inventive methods. Computing environment 100 includes, for example, computer 101, WAN (wide area network) 102, EV battery thermal control module 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and EV battery management program 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computing environment 100 contains an example of an environment for the execution of at least some of the computer code involved in performing the inventive methods, such as EV battery management program 150. In addition to EV battery management program 150, computing environment 100 includes, for example, computer 101, wide area network (WAN) 102, EV battery thermal control module 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and EV battery management program 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in EV battery management program 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150, referred to as EV battery management program 150, typically includes at least some of the computer code involved in performing the inventive methods.

EV battery management program 150 provides the following capabilities, but it is not limited to, i) identifying each battery cells within the traction battery pack to assess health conditions, heat generation patterns, optimal pre-heat temperatures, power storage capacities, and available power, ii) simulating, by using Computational Fluid Dynamics (CFD), the flow of air through the battery pack to identify an effective air flow path for cooling a first set of batteries currently in use and for pre-heating a second set of batteries to be used next, iii) controlling an array of valve-controlled airflow circuits within the traction battery case to dynamically adjust the direction of airflow (between each battery cells) based on the simulation results, iv) monitoring the heat generated by the first set of batteries to estimate the amount of recoverable heat for pre-heating the second set of batteries and determining the optimal air temperature for cooling the first set of batteries and v) switching to the second set of batteries to supply power to the vehicle when the second set of batteries reaches optimal pre-heat temperature and the first set of batteries approaches its heat generation threshold, thus enhancing the efficiency and performance of the traction battery pack through precise thermal management. It is noted that EV battery management program 150 may reside on EV battery thermal control module 103 or may reside on another device within computing environment 100.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EV battery thermal control module 103 can be an electronic control module that can communicates and/or control traction battery 210 and thermal management system 230. EV battery thermal control module may contain a computerized device, capable of executing EV battery management program 150 and an internal network device capable of receiving and transmitting data, via WAN 102, to and from computer 101 (network module 115).

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

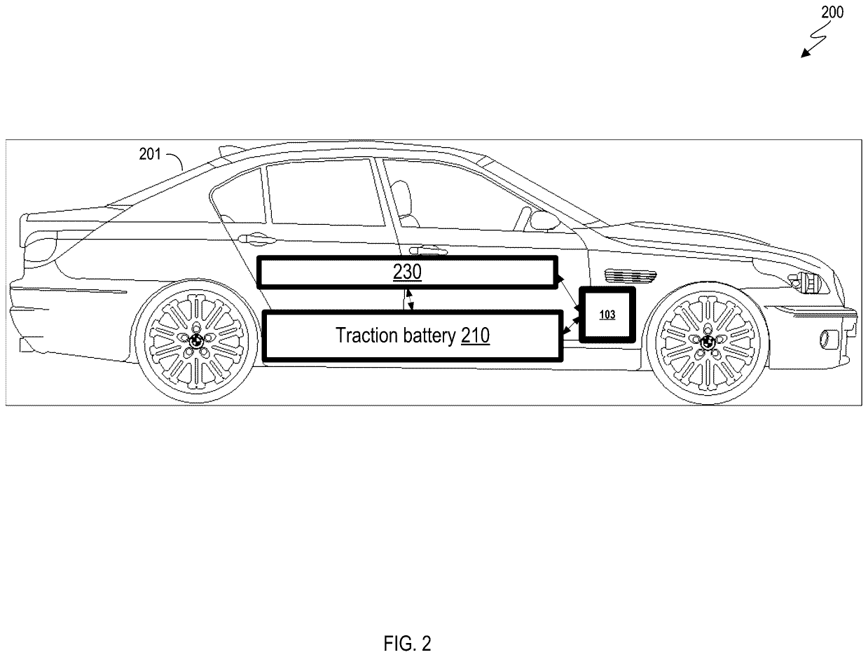

Referring now to various embodiments of the disclosure in more detail, FIG. 2 is a representation of EV battery management system 200. Many modifications to the depicted environment may be made by those skilled in the art without departing from the scope of the disclosure. EV battery management system 200 includes EV battery thermal control module 103, EV vehicle 201, traction battery 210 and thermal management system 230.

EV vehicle 201 are any vehicles used for transportation (e.g., leisure, commercial, etc.) that primary uses electric battery to provide locomotion. EV vehicle 201 may carry passengers and/or packages. EV vehicle 201 may traverse over land, water and air. Thus, EV vehicle 201 can be an aircraft, a boat or a car.

Traction battery 210 is an electrical source (i.e., battery) of power that allows locomotion (i.e., movement) for an EV vehicle. Traction battery 210 can be made up of various individual “cells” and can be compose of various metals (e.g., nickel, lithium, cadmium, etc.) and other minerals allowing it to store electrical energy. The individual cells can be wired in parallel or series to other cells to provide a specific voltage and energy capacity (kilowatts per hour) for the entire traction battery. For example, an EV can be composed of 7256 individual battery cells, when combined, the traction battery has a capacity rating of 75 kwh (kilowatts per hour).

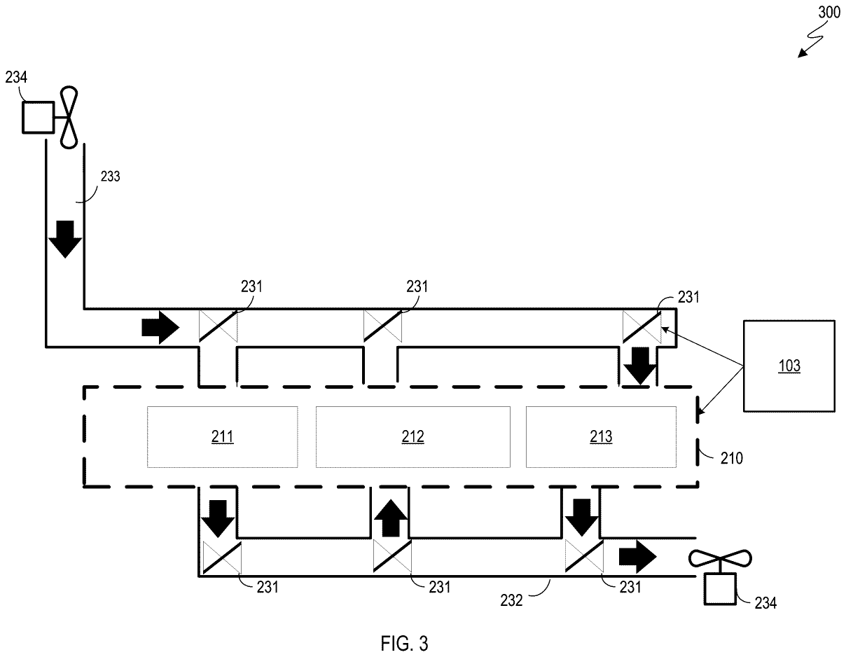

Thermal management system 230 is an electro-mechanical system that regulates the airflow around traction battery 210, more specifically, around each battery cell or cluster of battery cells (inside the traction battery casing/housing). Thermal management system 230 may include airflow ducts (e.g., solid or accordion style/flexible tubes), solenoid valves for opening and closing airflow ducts, fans and temperature sensors for each cell. Thermal management system 230 will be described in greater detail in FIG. 3.

FIG. 3 is a block diagram of an exemplary system,, designated as airflow circuits 300, depicting thermal management of individual cells in the traction battery (i.e., 210) coupled to thermal management system 230 and controlled by EV battery thermal control module 103, in accordance with aspects of the invention. In an example, as illustrated in FIG. 3, there are three battery cells (e.g., battery cell one 211, battery cell two 212 and battery cell three 213) that are coupled together in series to form the main traction battery. Thermal management system 230 comprises of one or more valves 231 controlled by solenoid fan 234 for drawing in air or expelling air to a certain direction inlet duct 233 and outlet duct 232. It is noted that knowledge of CFD (Computational Fluid Dynamics) may be leveraged to calculate and determine which individual battery cells that may need more cooling than others and/or the exhaust from one battery cell may be used to pre-heat another nearby cell.

### Heat Calculation

Heat measurement generated by each individual battery cells (e.g., battery cell one 211, battery cell two 212 and battery cell three 213) can be measured directly with temperature sensors coupled to the individual cells and other temperature sensors located long the inlet duct 233 and outlet duct 232. However, there are other methods of obtaining the heat measurement, indirectly, with a given formula. For example, the following formula can be used, “Heat Q_{b}=I*V*t*E”, where, Q_{b} is equivalent to the heat generated during discharge (in Joules or calories), and I denotes the current flowing through the battery (in Amperes), V denotes the voltage of the battery (in Volts), t denotes the discharge time (in seconds), E denotes the efficiency of the battery discharge process (expressed as a fraction or percentage). In the prior formula, I*V represents the power (P) dissipated during discharge, and t represents the time for which the battery is being discharged. Multiplying the power by the discharge time gives the energy (E) consumed during the discharge process. The efficiency factor (E) accounts for any losses during the discharge, such as internal resistance or inefficiencies in the battery chemistry.

In certain situations, such as in a cold environment, the process of preheating a battery can help to improve the battery performance. Certain types of “wet” batteries (i.e., contains electrolytes fluids), does not function optimally under certain temperature condition, especially in colder environments (i.e., at or below freezing point of liquids). The amount of heat required (to preheat) on individual battery cells inside a traction battery can be calculated using principles of thermodynamics. For example, an assumption is made, wherein the amount of heat, Q, is required to raise the temperature of an object. That amount of heat can be calculated using the formula, “Q=m*c*ΔT,” where the variable “m” is denoted as the mass of the battery (in kilograms), “c” as the specific heat capacity of the battery material (in joules per kilogram per degree Celsius) and “ΔT” as the temperature change needed (in degrees Celsius).

Continuing with the prior formula (i.e., amount of heat required), ambient temperature also needs to be measured. If the battery is initially measured at a temperature T₀ and the required temperature for effective use is T_{f}, then the temperature change (ΔT) would be T_{f}−T₀. So, the prior formula becomes, Q=m*c*(T_{f}−T₀). In this case, T₀ can vary based on, but not limited to, the actual environmental condition and the differences with environmental condition (i.e., different amount of preheat amount is required).

### Pre-Heating Calculation

When air is flowing through the airflow path, then the battery around the exposed area can be cooled (from the airflow). This process can be known as convective heat transfer. The primary formula for calculating convective heat transfer is “Qc=h*A*(Tb−Ta)*ta”, where, Qc is the rate of heat transfer, h is the convective heat transfer coefficient, A is the surface area of the of the battery from were heat is to be removed, Tb is the surface temperature of the battery, Ta is the air temperature is used for cooling and ta is the time for convection heat transfer. For the purpose of additional calculation (in subsequent paragraphs), this current equation (i.e., Q_{c}=h*A*(Tb−Ta)*ta) will now be designated as E1 since it'll be used later.

The generated heat by the batteries can be represented as “Q_{b}=I*V*t*E”, this equation will be designated as E2. Furthermore, the heat required for pre-heating batteries can be represented as “Q=m*c*(T_{f}−T₀)”, this equation will be designated as E3.

During airflow through the airflow path (e.g., inlet 233 and outlet 232), there will be some amount of heat loss and gained by the heat associated with the airflow. For example, when the cold air flows over the battery (i.e., individual cells), then the heat will be transferred from the cells to the surrounding air. In order to determine the length of time that is required for the subsequent battery cells that is waiting for pre-heating, there are several equations (including equations from prior paragraphs) that can be used. From equation, E1, and k is represented as the traction battery with the heat retention, the temperature of the air can be recalculated as, “Qa=k, Qc=k*h*A*(T_{b}−Tₐ)*ta (designated as E4). From equation, E3 is combine with E4, that can be rewritten as, “k*h*A*(T_{b}−Tₐ)*ta=m*c*(T_{f}−T₀)”, designated as E5.

Therefore, “ta” can be calculated (i.e., duration of time required to pre-heat a set of batteries before start using). After cooling is applied, the battery temperature which are being used currently will be reduced. In this case from equation E2 and E1, can be re-written, wherein the heat with the battery is being used as, “I*V*t*E−h*A*(Tb−Ta)*ta” (now designated as E6). Furthermore, if the remaining heat with the battery is more than the threshold limit, then switching is required, and timing of switching (heating) can be determined (now designated as E5).

### Inlet and Outlet Duct

In an embodiment, around each cell in the battery pack, there are airflow passages (referring to 233 and 234 of FIG. 3), where some airflow can be used for applying cooling and also pre-heating. The inlet duct of the airflow can be connected with a vehicle generated cooling system or can utilize fan 234, to apply and direct air flow through the individual battery cells. The outlet of the airflow can carry the hot air (after absorbing heat from a battery cell in use) to the specific cell (i.e., 211) in the battery pack. Thus, this hot air (from battery cell one 211) can be used for pre-heating second sets of cells (e.g., battery cell two 212).

In the same embodiment, inlet and outlet ducts can have an array of valves (see one or more valves 231 of FIG. 2), so that by controlling the valves, the airflow can be redirected. Thus, specific areas around the battery cells can be cooled and preheated. The valves may be electronically controlled (i.e., solenoid valves) for precise regulation. Furthermore, there can be temperature sensors integrated into the inlet and outlet ducts (not pictured). These temperature sensors can be evenly distributed through the ductwork (inlet and outlet).

In other embodiments, to optimize the number of valves, and to reduce the complexities, the battery pack can have different logical segments (i.e., many airflow circuits). Thus, segment wise cooling and pre-heating can be applied from the identified segment. In yet another embodiment, the airflow passage can be part of the casing of the battery pack, and the advantages can include, but is it not limited to, i) precise control the airflow in a selective manner, ii) efficiently receive heat from the batteries being used and iii) ability to reuse the same heat for pre-heating of other battery cells.

In another embodiment, traction battery 210 may be fully integrated with thermal management system 230. For example, the battery pack case may be integrated with airflow passages around its perimeter and these passages will allow air to flow uniformly around the battery cells.

### Simulations and Scenarios

Using CFD, the present invention can identify effective air flow path through the traction battery pack by using simulations and scenarios. It is noted that there can be other external EV factors that may be used as part of the CFD simulation. These, external EV factors can include, but is not limited to, i) user heating or cooling preference inside the EV, ii) travel speed of the EV, iii) distance remaining for EV to travel of final or first destination (for multiple stops) and iv) rolling resistance of the wheel and tires combination (this will impact EV range).

Referring back to the simulations, one example of a first scenario can include simulating the flow of air for cooling the first sets of battery cells currently being used and after extracting the heat from the sets of the first sets of batteries, how the same extracted heat can be used for pre-heating the second and subsequent sets of batteries. Furthermore, the present invention, based on the one or more possible solutions of the simulation, can dynamically adjust the valves (airflow) in the traction battery pack to create an airflow circuit. The airflow circuit can be defined as one or more passage (e.g., tunnels, tubes, etc.) that allow air to travel between sets of individual battery cells inside a battery pack (traction battery casing). Thus, there can be multiple airflow circuits within a battery pack since there can be numerous battery cells with interconnected “air passage” throughout the battery casing.

Another potential scenario for a CFD simulation may be to determine the optimal airflow path for effectively managing and utilizing the generated heat from the batteries. Another scenario for a CFD simulation can be to determine the most suitable second sets (or subsequent set) of batteries for continued use (after the depletion of the prior battery cell), optimizing heat generation management and cooling effectiveness.

Another scenario (for the simulation) may involve the use of historical data to determine how much heat will be generated by different batteries and can identify the relative position of the battery pack. Other factors that may be used in this simulation may involve, but it is not limited to, i) measurement of the heat generation on any battery, ii) health of the battery and iii) sensors installed.

In another scenario (for the simulation) may involve a comparison of heat generation (via temperature sensors) from each individual battery cells and the rate of cooling for those battery cells. Furthermore, the simulation can determine the optimal temperature of the air for the cooling, and after how long the battery can be switched based on the estimated heat generated by the battery and estimated heat required to pre-heat the subsequent battery.

In yet another scenario, when the second set of battery cells has reached their optimal pre-heat temperature and the first sets of battery cells approach their heat generation threshold due to usage with optimum temperature of the air used for cooling, the system will dynamically switch to the second sets of batteries to supply power to the vehicle. This pre-heating process enhances the effectiveness and performance of the second sets of batteries.

In another scenario, system evaluates the health of the selected first sets of batteries supplying power to the vehicle to estimate the heat generated during usage and the amount of heat that can be recovered to pre-heat the second sets of batteries, determines the optimal timing for switching to the second sets, accordingly the system can identify the appropriate air temperature needed for cooling the first sets of batteries, ensuring efficient thermal management and optimal battery performance.

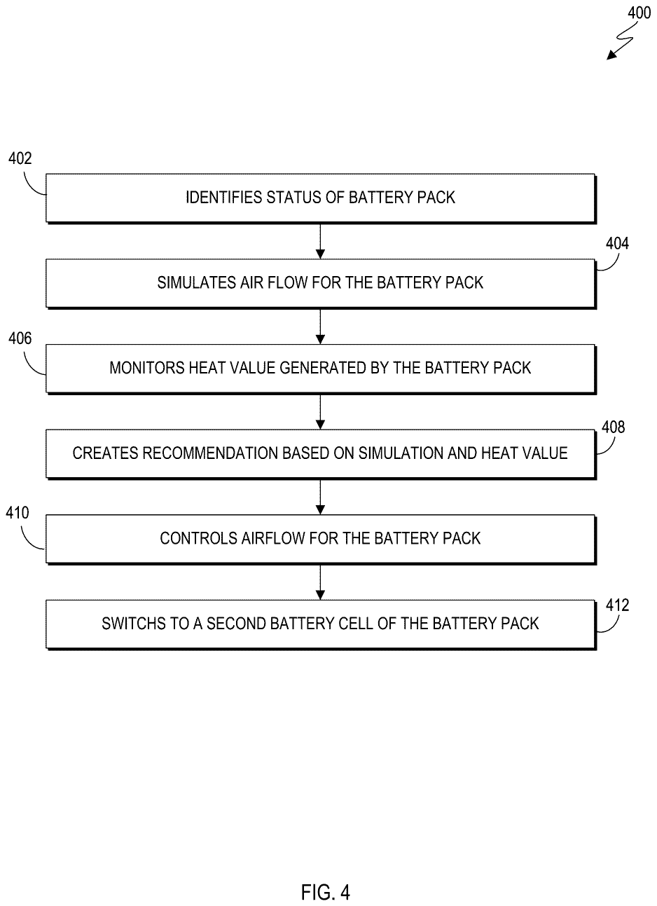

FIG. 4 illustrates a flowchart, as one embodiment, depicting the execution of EV battery management program 150 as method 400, which optimizes airflow path for effectively managing and utilizing the generated heat from the EV batteries.

At operation 402 of method 400, EV battery management program 150 identifies each of a plurality of battery cells within the battery pack to assess battery factors that are used to determine battery health. For example, the battery factors can include, but are not limited to, battery factors of each battery cells within a battery pack to assess health conditions, heat generation patterns, optimal pre-heat temperatures, power storage capacities, and available power.

At operation 404 of method 400, EV battery management program 150 executes simulations, by leveraging CFD, as various scenarios. For example, a first scenario can calculate the flow of air through the battery pack (i.e., airflow circuit), specifically how much heat is required to preheat a second battery cell based on the flow of air between the first battery cell to the second battery cell. In another example, a second scenario can include determining an optimal cooling temperature for another airflow circuit relating to another set of battery cells. Other scenarios may include, but are not limited to, i) determining which individual battery cell should be used after a depletion of the first battery cell, ii) determining individual heat values generated by each battery cell based on historical data usage, iii) determining amount of heat required for pre-heating of each battery cell and iv) determining an optimal battery timing for switching from one battery cell to another battery cell.

At operation 406 of method 400, EV battery management program 150 monitors a heat value generated from the airflow circuit (mentioned in operation 404). For example, the monitoring may include, estimating (i.e., heat calculation by various formulas) an amount of recoverable heat for pre-heating the second battery cell and determining an optimal air temperature for cooling the first battery cell.

At operation 408 of method 400, EV battery management program 150 creates a recommendation based on a first result from a first simulation associated with the first scenario and the first heat value. The recommendation can include, but is not limited to, i) switching to the second battery cell to supply power to the vehicle occurs when the second battery cell reaches a predetermined pre-heat temperature and the first battery cells approaches its heat generation threshold, ii) calculating the predetermined pre-heat temperature associated with the second battery cell based on the distance remaining and time remaining for the trip and iii) determining remaining energy level of the battery pack based on climate setting of EV for one or more users. It is noted that there can be multiple recommendations as a result of the simulation based on a given scenario.

At operation 410 of method 400, EV battery management program 150 controls an array of valves (i.e., 231) and/or fan 234 associated with the airflow circuit based on the recommendation. For example, EV battery management program 150 has determined that time required for the first battery cell (see 211 of FIG. 3) to reach a predetermined temperature that can be used to preheat the second battery cell (see 212 of FIG. 3) is 10 minutes. Thus, in 10 minutes, EV battery management program 150 can control the valve and/or fans that allows airflow into battery cell one 211 to open and close all other valves so that the exiting (heated air) air from battery cell one 211 is channeled into battery cell two 212.

At operation 412 of method 400, EV battery management program 150 switches from the first battery cell to a second battery cell based on the first recommendation. For example, after having determined to control (i.e., direction) the air valves in 10 minutes, battery cell one 211 will be at 50% capacity and that it is optimal (i.e., two minutes) to switch from battery cell one 211 to battery cell two 212. It is noted that the term “optimal” may be defined by the user as predetermined time based on the given situation (e.g., external air temperature, distance left to travel, etc.).

The entire process can be repeated for all or some of the individual cells of the traction battery, depending on the specific use case of the EV.

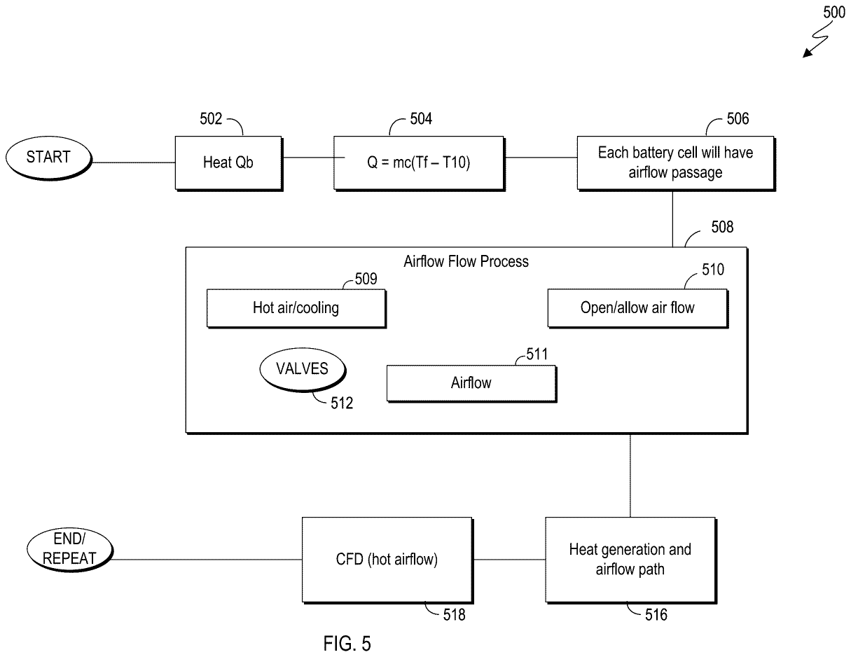

FIG. 5 illustrates another flowchart, as another embodiment and designated as hi-level overview EV 500, depicting a high-level process flow of EV battery management system 200.

At operation 502 and operation 504, EV battery management system 200 determines the heat generated by the individual battery (from the traction battery) during discharge. Thermodynamic equations and formulas (e.g., 502 and 504) can be utilized to indirectly determine heat from the battery cells.

At operation 506, it is assumed that there are airflow ducts/passages between individual battery cells inside the traction battery.

Operation 508 is designated as “Airflow Process”, contains sub-processes, such as hot air/cooling 509, valves 512, airflow 511 and open/allow airflow 510. All the sub-processes work in tandem to, control volume and direction of the airflow. Valves 512 can be controlled to open or direct, via open/allow airflow 510, either the hot or cooling (i.e., 509) air flow (i.e., airflow 511) to a certain section inside the traction battery.

At operation 516, EV battery management system 200 determines heat generated from various individual battery cells and how to direct the airflow towards a specific airflow path (airflow circuits).

At operation 518, EV battery management system 200 determines the hot airflow path and amount of heat by using CFD methods. The cycle can be repeated.

1. A computer-implemented method for optimizing a battery pack of an electric vehicle (EV) comprising:
identifying each of a plurality of battery cells within the battery pack to assess battery factors;
simulating a first scenario from a plurality of scenarios, by computational fluid dynamics (CFD), a first flow of air through the battery pack;
monitoring a first heat value generated from a first airflow circuit within the battery pack, wherein the first airflow circuit is between a first battery cell of the plurality of battery cells and a second battery cell of the plurality of battery cells;
creating a first recommendation based on a first result from a first simulation associated with the first scenario and the first heat value;
controlling, based on a first result of the first recommendation, a first array of valves associated with the first airflow circuit, wherein the first array of valves controls the first flow of air within the one or more airflow circuits; and
switching from the first battery cell to a second battery cell based on the first recommendation.

2. The computer-implemented method of claim 1, further comprising:
simulating a second scenario of the plurality of scenarios, by CFD, wherein the second scenario comprises an optimal cooling temperature associated with a second airflow circuit;
creating a second recommendation based on the result from a second simulation associated with the second scenario;
monitoring a second heat value generated by the second airflow circuit, wherein the second airflow circuit connects a second battery cell associated with the plurality of battery cells to a third battery cell associated with the plurality of battery cells;
dynamically, controlling a second array of valves associated with the second airflow circuit based on the result of the second recommendation and the second heat value; and
switching from the second battery cell to the third battery cell based on a second recommendation from the second recommendation.

3. The computer-implemented method of claim 1, wherein the first scenario of the plurality of scenarios determines how much of the first heat value is required to preheat the second battery cell.

4. The computer-implemented method of claim 1, wherein the first recommendation comprises i) switching to the second battery cell to supply power to the vehicle occurs when the second battery cell reaches a predetermined pre-heat temperature and the first battery cells approaches its heat generation threshold, ii) calculating the predetermined pre-heat temperature associated with the second battery cell based on a distance remaining and time remaining for a trip and iii) determining remaining energy level of the battery pack based on climate setting of EV for one or more users.

5. The computer-implemented method of claim 1, wherein the plurality of scenarios further comprises i) determining which individual battery cell should be used after a depletion of the first battery cell, ii) determining individual heat values generated by each battery cell based on historical data usage, iii) determining amount of heat required for pre-heating of each battery cell and iv) determining an optimal battery timing for switching from one battery cell to another battery cell.

6. The computer-implemented method of claim 1, wherein the battery factors comprise health conditions, heat generation patterns, optimal pre-heat temperatures, power storage capacities, and available power.

7. The computer-implemented method of claim 1, wherein monitoring the heat generated by the first battery cell further comprises:
estimating an amount of recoverable heat for pre-heating the second battery cell and determining an optimal air temperature for cooling the first battery cell.

8. The computer-implemented method of claim 1, wherein the one or more airflow circuits connects each of the battery cell to another battery cell of the plurality of battery cells inside the battery pack.

9. A computer program product for optimizing a battery pack of an EV (electric vehicle) comprising:
one or more non-transitory computer-readable storage media and program instructions stored on the one or more non-transitory computer-readable storage media capable of performing a method, the method comprising:
identifying each of a plurality of battery cells within the battery pack to assess battery factors;
simulating a first scenario from plurality of scenarios, by CFD (computational fluid dynamics), a first flow of air through the battery pack;
monitoring a first heat value generated from a first airflow circuit within the battery pack, wherein the first airflow circuit is between a first battery cell of the plurality of battery cells and a second battery cell of the plurality of battery cells;
creating a first recommendation based on a first result from a first simulation associated with the first scenario and the first heat value;
controlling, based on a first result of the first recommendation, a first array of valves associated with the first airflow circuit, wherein the first array of valves controls the first flow of air within the one or more airflow circuits; and
switching from the first battery cell to a second battery cell based on the first recommendation.

10. The computer program product of claim 9, further comprising:
simulating a second scenario of the plurality of scenarios, by CFD, wherein the second scenario comprises an optimal cooling temperature associated with a second airflow circuit; creating a second recommendation based on the result from a second simulation associated with the second scenario;
monitoring a second heat value generated by the second airflow circuit, wherein the second airflow circuit connects a second battery cell associated with the plurality of battery cells to a third battery cell associated with the plurality of battery cells;
dynamically, controlling a second array of valves associated with the second airflow circuit based on the result of the second recommendation and the second heat value; and
switching from the second battery cell to the third battery cell based on a second recommendation from the second recommendation.

11. The computer program product of claim 9, wherein the first scenario of the plurality of scenarios determines how much of the first heat value is required to preheat the second battery cell.

12. The computer program product of claim 9, wherein the first recommendation comprises i) switching to the second battery cell to supply power to the EV occurs when the second battery cell reaches a predetermined pre-heat temperature and the first battery cells approaches its heat generation threshold, ii) calculating the predetermined pre-heat temperature associated with the second battery cell based on a distance remaining and time remaining for a trip and iii) determining remaining energy level of the battery pack based on climate setting of EV for one or more users.

13. The computer program product of claim 9, wherein the plurality of scenarios further comprises i) determining which individual battery cell should be used after a depletion of the first battery cell, ii) determining individual heat values generated by each battery cell based on historical data usage, iii) determining amount of heat required for pre-heating of each battery cell and iv) determining an optimal battery timing for switching from one battery cell to another battery cell.

14. The computer program product of claim 9, wherein the battery factors comprise health conditions, heat generation patterns, optimal pre-heat temperatures, power storage capacities, and available power.

15. A computer system for optimizing a battery pack of an EV (electric vehicle) comprising: one or more computer processors;
one or more computer-readable storage media, and program instructions stored on the one or more of the computer-readable storage media for execution by at least one of the one or more processors capable of performing a method, the method comprising:
identifying each of a plurality of battery cells within the battery pack to assess battery factors;
simulating a first scenario from plurality of scenarios, by CFD (computational fluid dynamics), a first flow of air through the battery pack;
monitoring a first heat value generated from a first airflow circuit within the battery pack, wherein the first airflow circuit is between a first battery cell of the plurality of battery cells and a second battery cell of the plurality of battery cells;
creating a first recommendation based on a first result from a first simulation associated with the first scenario and the first heat value;
controlling, based on a first result of the first recommendation, a first array of valves associated with the first airflow circuit, wherein the first array of valves controls the first flow of air within the one or more airflow circuits; and
switching from the first battery cell to a second battery cell based on the first recommendation.

16. The computer system of claim 15, further comprising:
simulating a second scenario of the plurality of scenarios, by CFD, wherein the second scenario comprises an optimal cooling temperature associated with a second airflow circuit;
creating a second recommendation based on the result from a second simulation associated with the second scenario;
monitoring a second heat value generated by the second airflow circuit, wherein the second airflow circuit connects a second battery cell associated with the plurality of battery cells to a third battery cell associated with the plurality of battery cells;
dynamically, controlling a second array of valves associated with the second airflow circuit based on the result of the second recommendation and the second heat value; and
switching from the second battery cell to the third battery cell based on a second recommendation from the second recommendation.

17. The computer system of claim 15, wherein the first scenario of the plurality of scenarios determines how much of the first heat value is required to preheat the second battery cell.

18. The computer system of claim 15, wherein the first recommendation comprises i) switching to the second battery cell to supply power to the vehicle occurs when the second battery cell reaches a predetermined pre-heat temperature and the first battery cells approaches its heat generation threshold, ii) calculating the predetermined pre-heat temperature associated with the second battery cell based on a distance remaining and time remaining for a trip and iii) determining remaining energy level of the battery pack based on climate setting of EV for one or more users.

19. The computer system of claim 15, wherein the plurality of scenarios further comprises i) determining which individual battery cell should be used after a depletion of the first battery cell, ii) determining individual heat values generated by each battery cell based on historical data usage, iii) determining amount of heat required for pre-heating of each battery cell and iv) determining an optimal battery timing for switching from one battery cell to another battery cell.

20. The computer system of claim 15, wherein the battery factors comprise health conditions, heat generation patterns, optimal pre-heat temperatures, power storage capacities, and available power.
